(19) United States
(12) Patent Application Publication
(10) Pub. No.: US 2026/0252092 A1
(43) Pub. Date: Aug. 27, 2026

(54) VEHICLE

(71) Applicant: KAWASAKI MOTORS, LTD., Hyogo (JP)

(72) Inventors: Shohei TERAI, Hyogo (JP); Osamu TANI, Hyogo (JP); Takenori SEGAWA, Hyogo (JP); Yoshiki HISAMOTO, Hyogo (JP); Kouji ITO, Hyogo (JP)

(73) Assignee: KAWASAKI MOTORS, LTD., Hyogo (JP)

(21) Appl. No.: 19/541,440

(22) Filed: Feb. 17, 2026

Related U.S. Application Data
(60) Provisional application No. 63/761,319, filed on Feb. 21, 2025.

(51) Int. Cl. G05D 1/617; G01C 21/34; G05D 107/30

(52) U.S. Cl. CPC G05D 1/617; G01C 21/3461; G05D 2107/30

(57) ABSTRACT

A vehicle includes a traveling device, a controller capable of causing the vehicle to travel autonomously by outputting a travel command to the traveling device, and a surrounding environment detection unit including at least one sensor that detects a surrounding situation of the vehicle and outputs the detected surrounding situation to the controller. The controller acquires output information output by the surrounding environment detection unit, and determines whether or not the acquired output information includes an abnormal section differing from an assumed output. The controller is configured to cause a change in behavior of the vehicle when the abnormal section is present.

### CROSS-REFERENCE TO RELATED APPLICATION

This application claims the benefit of priority to U.S. Provisional Patent Application No. 63/761,319 filed on Feb. 21, 2025, the entire contents of which are incorporated herein by reference.

### TECHNICAL FIELD

The present disclosure relates to a vehicle.

### BACKGROUND OF THE INVENTION

In JP 2020-013379 A, a vehicle is disclosed that includes a controller capable of detecting an environment state of a travel route, as environment information, and causing the vehicle to travel autonomously.

### SUMMARY OF THE INVENTION

According to a first aspect of the present disclosure, a vehicle is provided. The vehicle is an off-road vehicle configured to travel over rough terrain. The vehicle includes a traveling device configured to cause the vehicle to travel, a controller, and a surrounding environment detection unit. The controller is configured to cause the vehicle to perform autonomous travel, by outputting a travel command to the traveling device. The surrounding environment detection unit includes at least one sensor configured to detect a surrounding situation of the vehicle and output the detected surrounding situation to the controller. The controller is configured to acquire output information output by the surrounding environment detection unit, determine whether or not the acquired output information includes an abnormal section differing from an assumed output, and cause a change in behavior of the vehicle when the abnormal section is present.

According to this aspect, an impact of the abnormal section on vehicle travel can be reduced.

### BRIEF DESCRIPTION OF DRAWINGS

FIG. 1 is a schematic configuration view of a vehicle.

FIG. 2 is a system configuration view of the vehicle.

FIG. 3 is a flowchart showing an example of route planning processing.

FIG. 4 is a flowchart showing an example of behavior change processing based on a contamination determination.

FIG. 5 is a flowchart showing an example of contamination detection processing.

FIG. 6 is a flowchart showing an example of contamination amount calculation processing.

### DETAILED DESCRIPTION OF THE INVENTION

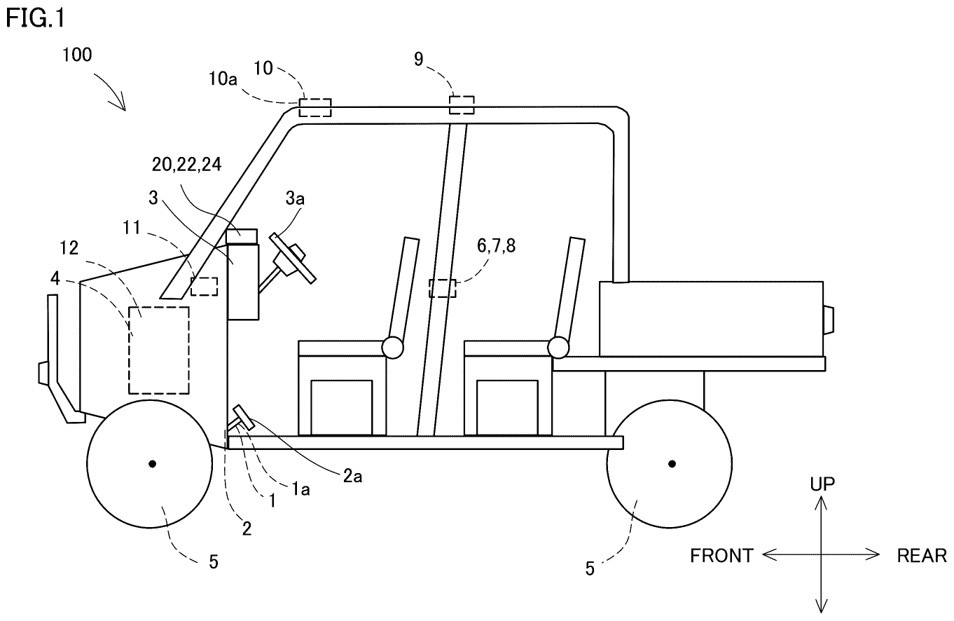

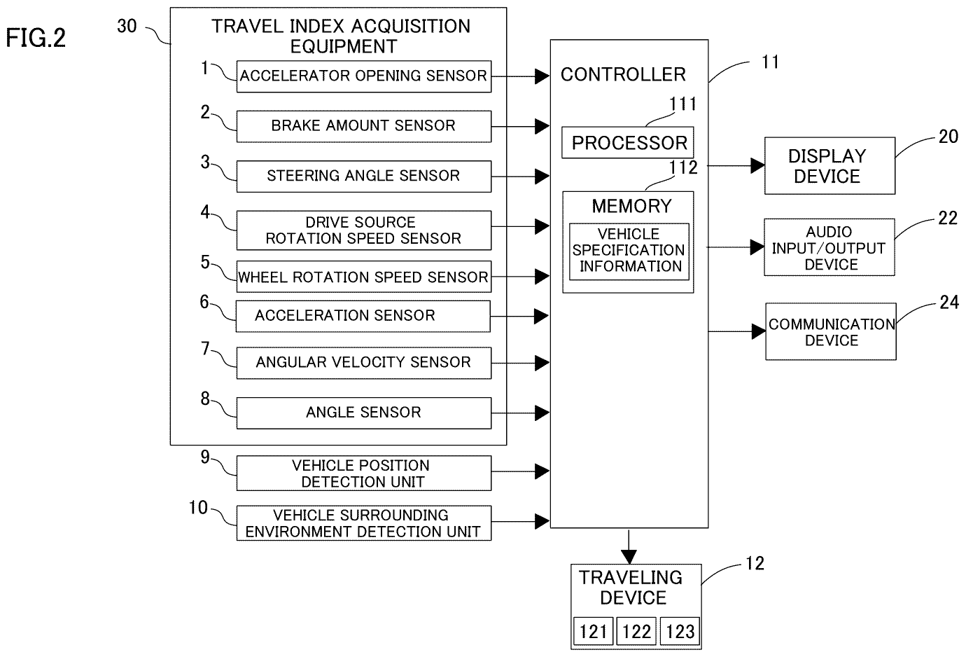

FIG. 1 is a schematic configuration view of a vehicle 100 according to an embodiment of the present disclosure. FIG. 2 is a schematic system configuration view of the vehicle 100. The vehicle 100 according to the present embodiment includes a rollover protective structure (ROPS) and is an off-road vehicle that travels over rough terrain. The vehicle 100 is configured to travel on terrain that is not paved, such as earth, mud, rocks and the like in a desert or a forest, for example. Hereinafter, the configuration of the vehicle 100 will be described with reference to FIG. 1 and FIG. 2. In each of the drawings, the vehicle 100 is exemplified by a configuration to which reference signs are allocated. An arrangement and size of each of the configurations (each of components) in the drawings do not represent an accurate arrangement and size.

The vehicle 100 according to the present embodiment is configured to travel in an automatic operation mode and a manual operation mode. The automatic operation mode is an operation mode in which the vehicle 100 travels autonomously along a planned route. In the automatic operation mode, the vehicle 100 travels regardless of an operation by a driver of an accelerator pedal 1a, a brake pedal 2a, and a steering wheel 3a, which are driving operation devices. In the manual operation mode, the vehicle 100 travels in accordance with the operation of the driving operation devices by the driver. In another embodiment, the vehicle 100 may be configured to be capable of automatic operation in an unmanned state in which the driver is not on board. In this case, the vehicle 100 need not necessarily be provided with the driving operation devices. In the present disclosure, the driver can also be referred to as an occupant, as appropriate.

The vehicle 100 includes a traveling device 12, travel index acquisition equipment 30, a vehicle position detection unit 9, a vehicle surrounding environment detection unit 10, a controller 11, a display device 20, an audio input/output device 22, and a communication device 24.

The traveling device 12 includes a drive device 121, a braking device 122, and a steering device 123. The drive device 121 is a device configured to output a drive force to be imparted to the vehicle 100, in order to cause the vehicle 100 to travel. The drive device 121 is, for example, an internal combustion engine, a motor, or the like. The braking device 122 is a device configured to output a braking force to be imparted to the vehicle 100, in order to brake the vehicle 100. The braking device 122 is a brake device, for example. The steering device 123 is a device configured to output a steering force to be imparted to the vehicle 100, in order to steer the vehicle 100. The steering device 123 is a steering device, for example. In the manual operation mode, the drive device 121, the braking device 122, and the steering device 123 respectively operate in accordance with operation of the accelerator pedal 1a, the brake pedal 2a, and the steering wheel 3a. In the automatic operation mode, the drive device 121, the braking device 122, and the steering device 123 respectively operate in accordance with travel commands output from the controller 11, regardless of the operation of the accelerator pedal 1a, the brake pedal 2a, and the steering wheel 3a.

The travel index acquisition equipment 30 detects information indicating a travel state of the vehicle 100 (behavior of the vehicle 100). As shown in FIG. 2, for example, the travel index acquisition equipment 30 includes an accelerator opening sensor 1, a brake amount sensor 2, a steering angle sensor 3, a drive source rotation speed sensor 4, a wheel rotation speed sensor 5, an acceleration sensor 6, an angular velocity sensor 7, and an angle sensor 8.

The accelerator opening sensor 1 detects an operation amount of the accelerator pedal 1a. The brake amount sensor 2 detects an operation amount of the brake pedal 2a. The steering angle sensor 3 detects an operation direction and an operation amount of the steering wheel 3a, by detecting a steering angle of the steering wheel 3a.

The drive source rotation speed sensor 4 detects a rotation speed of an output shaft of a drive source. The wheel rotation speed sensor 5 detects a rotation speed of a drive wheel. The wheel rotation speed sensor 5 may detect a rotation speed of non-driven wheels. The acceleration sensor 6 is an inertial sensor, and detects an external force acting on the vehicle 100. The angular velocity sensor 7 detects a wheel angular velocity. The angle sensor 8 is a gyro sensor, and detects a posture of the vehicle 100. The vehicle 100 may further include various sensors, such as a stroke sensor provided on a suspension or the like. The posture of the vehicle 100 may be estimated from a degree of acceleration obtained by performing an arithmetic operation on an expansion/contraction amount of the stroke sensor provided on the suspension and a detection result of the stroke sensor.

The vehicle position detection unit 9 (the vehicle position detector) is configured to detect the position of the vehicle 100. The position of the vehicle 100 can also be said to be a vehicle position, or a self-position. In the present embodiment, the vehicle position detection unit 9 includes a global navigation satellite system (GNSS). The vehicle position detection unit 9 may output, as the vehicle position, a position obtained by performing an arithmetic operation on detection results of a wheel velocity sensor, an inertial sensor, and the like. In addition to or in place of the GNSS, the vehicle position detection unit 9 may acquire position information of the vehicle 100 from a ground base station, via the communication device 24.

The vehicle surrounding environment detection unit 10 detects a route on which the vehicle 100 is to travel, and a situation surrounding the vehicle 100 (surrounding situation). The vehicle surrounding environment detection unit 10 includes at least one sensor. The vehicle surrounding environment detection unit 10 includes a camera as the sensor, for example. In addition to the camera, the vehicle surrounding environment detection unit 10 may include a distance sensor that uses radar, laser, infrared, sound waves, or the like.

The vehicle surrounding environment detection unit 10 includes a sensor that is able to detect irregularities and an inclination (gradient, ups and downs) of a road surface. Of the irregularities of the road surface, the vehicle surrounding environment detection unit 10 is preferably configured to detect a protrusion having a width smaller than a vehicle width of the vehicle 100, and a recess (depression) having a width smaller than the vehicle width of the vehicle 100. Of the irregularities of the road surface, the protrusion having the width smaller than the vehicle width of the vehicle 100 will also be referred to as a road surface protrusion. Of the irregularities of the road surface, the recess having the width smaller than the vehicle width of the vehicle 100 will also be referred to as a road surface recess. The road surface protrusion may be a fallen tree or a fallen rock, for example. The road surface recess may be a crevice, a ditch, or a rut, for example.

The vehicle surrounding environment detection unit 10 is configured to determine whether or not a height of the road surface protrusion is higher than a ground clearance of the vehicle 100. The ground clearance is a height of a bottom surface of the vehicle 100 from a ground contact surface of the tires of the vehicle 100. The vehicle surrounding environment detection unit 10 is preferably configured to detect a road width of the road surface that can be traveled on. The recognition of the road surface protrusions and the road surface recesses in the vehicle surrounding environment detection unit 10 may be realized by a learning algorithm using image processing.

The vehicle surrounding environment detection unit 10 outputs, to the controller 11, information (output information) relating to the detected surrounding situation. For example, the output information may include information for each of a plurality of divided regions obtained by dividing the surrounding situation using a predetermined grid.

As shown in FIG. 1, the vehicle surrounding environment detection unit 10 includes a foreign material removal device 10a. The foreign material removal device 10a has a function to remove foreign material attached to the at least one sensor provided in the vehicle surrounding environment detection unit 10. For example, the foreign material removal device 10a may be configured to include at least one of a washer, a wiper, a vibrator, an air jet, a heater for defogging or the like.

The communication device 24 communicates with the outside of the vehicle 100 via a public network or the like. The communication with the outside of the vehicle 100 includes a management center of the vehicle 100, or a server device provided at a position separated from the vehicle 100. The communication device 24 need not necessarily be installed in the vehicle 100. The communication device 24 may be provided in a mobile device, such as a smartphone or a tablet terminal carried by the driver. The controller 11 may communicate with the outside of the vehicle 100 via the mobile device.

The display device 20 includes a display of an instrument panel or a navigation device, for example. The audio input/output device 22 includes a microphone and a speaker, for example. The vehicle 100 can perform notification of various information, such as the travel state of the vehicle 100, a warning, or the like, via the display device 20 and the audio input/output device 22, or the like. The vehicle 100 is configured to allow the driver to input various information relating to route planning, such as the current position, the target location, or the like, via the display device 20 and the audio input/output device 22, or the like. The vehicle 100 may be configured to allow, via the display device 20 and the audio input/output device 22, selection of the operation mode of the vehicle 100, or the input of information relating to settings and the like of various determination conditions in processing to be described later.

The controller 11 includes a processor 111 and a memory 112. The controller 11 is configured to transmit and receive signals with each of the components of the vehicle 100. Detection results (signals) of the travel index acquisition equipment 30, the vehicle position detection unit 9, and the vehicle surrounding environment detection unit 10 are input to the controller 11, for example. Further, various signals are input to the controller 11, for example, from the display device 20 and the audio input/output device 22.

For example, the processor 111 acquires the output information from the vehicle surrounding environment detection unit 10 at a predetermined cycle, and stores the acquired output information in the memory 112. The output information acquired within a predetermined period is saved (stored) in the memory 112 in a time sequential manner. The processor 111 updates the output information saved in the time sequential manner using the newly acquired output information.

The controller 11 outputs various commands (signals) to the drive device 121, the brake device 122, and the steering device 123 of the traveling device 12, in order to cause the vehicle 100 to travel autonomously, and causes the vehicle 100 to travel autonomously by controlling these devices. The commands output from the controller 11 to the traveling device 12 will also be referred to as travel commands and autonomous commands. Further, the controller 11 can acquire various information from the display device 20 and the audio input/output device 22, and can output various information to the display device 20 and the audio input/output device 22.

The controller 11 can execute various processing. For example, the controller 11 decides (generates) the travel plan of the vehicle 100. The controller 11 controls the traveling device 12 such that the vehicle 100 travels autonomously in accordance with the decided travel plan. The travel plan includes the route from a departure location (current position) to the target location, and travel conditions, such as the vehicle speed, a drive state, and the like of the vehicle 100. The travel plan will also be referred to as a route plan or the route planning.

Various processing further includes behavior change processing based on a contamination determination. This processing is processing that determines the presence or absence of contamination of the vehicle surrounding environment detection unit 10 and, based on the result of this determination, causes a change in behavior of the vehicle 100. The behavior change processing based on the contamination determination will be described in detail later.

The controller 11 can accelerate and decelerate the vehicle 100, can steer the vehicle 100, and can execute the switching of the drive state of the vehicle 100, and the like by controlling the various components of the vehicle 100. The switching of the drive state includes switching the vehicle 100 between two-wheel drive and four-wheel drive, switching between a differential-free state and a differential-lock state, changing a gear ratio, switching between a forward movement state and a reverse movement state, and the like.

The controller 11 may decide (generate) the travel plan before the travel of the vehicle 100, may generate the travel plan during the travel of the vehicle 100, or may change the decided travel plan, as needed, during the travel of the vehicle 100. The changing of the travel plan may include traveling a detour route that makes a detour from the departure location to the target location, changing (suppressing) a decided travel speed, or the like.

Vehicle specification information that indicates the vehicle class or performance of the vehicle 100 is stored in advance in the memory 112. The vehicle specification information includes various information relating to the vehicle 100, such as a total length, a total width, a wheel diameter, a wheel base, and a designed minimum turning radius of the vehicle 100, and the like, for example.

Map information may be further stored in the memory 112. The map information may be acquired from outside via the communication device 24. The map information preferably includes information relating to the ups and downs and inclination of the road surface, and information that can be detected by the vehicle surrounding environment detection unit 10. The controller 11 may update the map information based on information and the like provided from one or more vehicles around the vehicle 100 and acquired by the communication device 24.

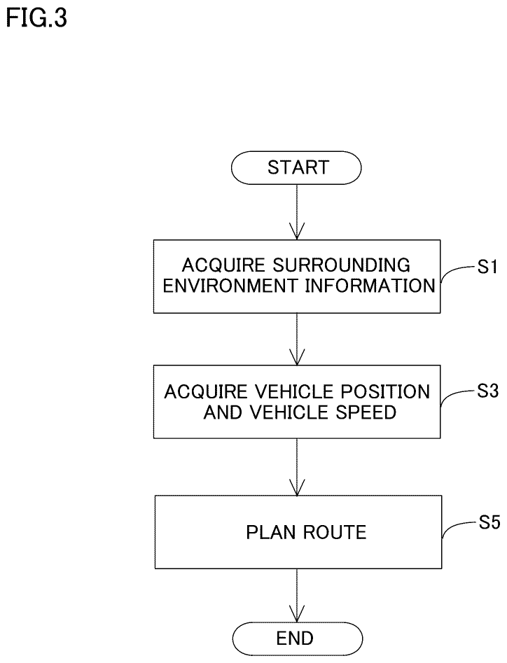

FIG. 3 is a flowchart showing an example of route planning processing executed by the processor 111 of the controller 11. The route planning processing is executed when the operation mode of the vehicle 100 is the automatic operation mode, for example. For example, at a predetermined interval, the processor 111 of the controller 11 generates (decides) the travel plan, which includes a departure position, the route from the current position to the target location, and the travel conditions such as the speed and drive state of the vehicle 100, and causes the vehicle 100 to travel autonomously based on the decided travel plan. Causing the vehicle 100 to travel autonomously based on the travel plan (the route) may mean causing the vehicle 100 to travel along the route, or may mean the processor 111 amending (correcting, changing) the route in the travel plan, in accordance with the road surface situation or the like.

At step S1, the processor 111 acquires surrounding environment information of the vehicle 100, via the vehicle surrounding environment detection unit 10.

At step S3, the processor 111 acquires the vehicle position and the vehicle speed.

At step S5, the controller 11 generates the travel plan, which includes the route and the travel conditions, based on the information acquired at step S1 and step S3. The controller 11 controls the traveling device 12 such that the vehicle 100 travels autonomously in accordance with the travel plan.

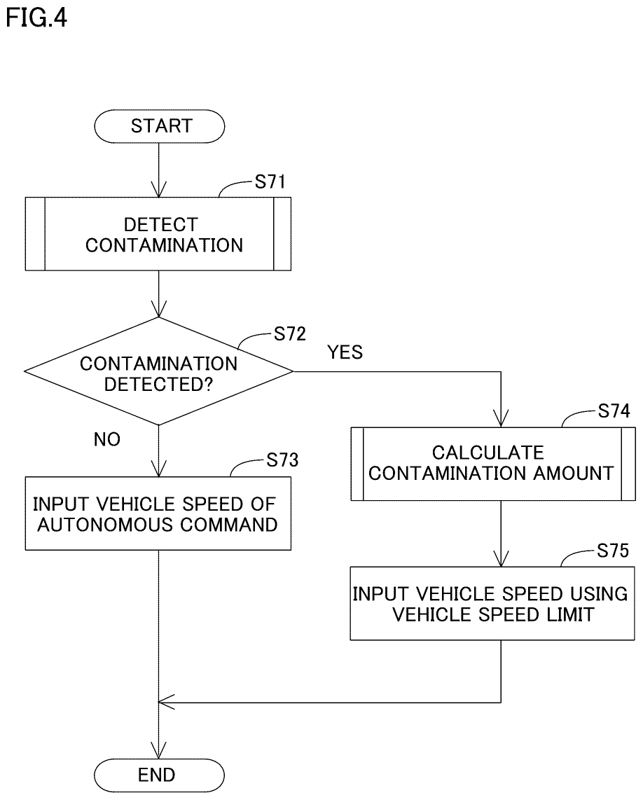

FIG. 4 is a flowchart showing an example of the behavior change processing based on the contamination determination. In the present embodiment, this processing is repeatedly executed in parallel with the route planning processing when the operation mode of the vehicle 100 is the automatic operation mode.

At step S71, the processor 111 executes contamination detection processing. The contamination detection processing is processing that determines whether or not, in the output information acquired by the processor 111, an abnormal section, which is a section different from an assumed output, is present. The assumed output may differ depending on a configuration of the sensors included in the vehicle surrounding environment detection unit 10, and is, for example, the output when a contaminant is not attached to a sensing surface or a detection window of a lens, a cover, a light-emitting unit, a light-receiving unit of the sensor, or the like. The contaminant may include fogging. The assumed output may be calculated by experimentation or simulation and stored in advance in the memory 112.

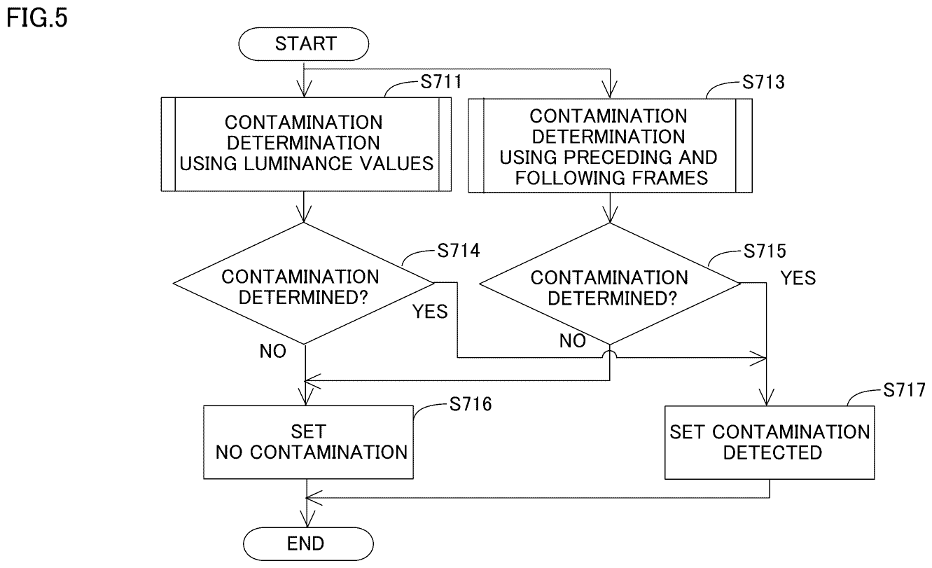

FIG. 5 is a flowchart showing an example of the contamination detection processing at step S71. In the present embodiment, the processor 111 executes the contamination determination (step S711) using luminance values, and the contamination determination (step S713) using preceding and following frames.

As described above, in the present embodiment, at the predetermined cycle, the sensors included in the vehicle surrounding environment detection unit 10 output, to the controller 11, the information relating to the surrounding situation of the vehicle 100, as the information for each of the plurality of divided regions. At step S711, the processor 111 determines whether or not luminance values for each of the regions are assumed luminance values. When there is no region for which the luminance value is different from the assumed luminance value (no abnormal section), the processor 111 makes a negative determination at step S714, and sets “No contamination” at step S716. On the other hand, when the abnormal section is present, the processor 111 makes a positive determination at step S714, and sets “Contamination detected” at step S717. The assumed luminance values may be specific values (predetermined luminance values). The predetermined luminance values may be calculated by experimentation or simulation. When there is the region for which the luminance value differs from the predetermined luminance value, the processor 111 may treat the region as the abnormal section. Further, the region for which the luminance value differs from the predetermined luminance value may be a region, of the plurality of divided regions, having a low luminance value compared to the surrounding divided regions, and the processor 111 may treat the region as the abnormal section when it is the region having the low luminance value compared to the surrounding divided regions.

Further, in the contamination determination using the preceding and following frames (step S713), the processor 111 determines whether or not, of the plurality of divided regions, there is the region for which an update frequency is lower compared to the other regions. For example, for a frame that is the output information stored in the time sequential manner in the memory 112, the processor 111 compares the acquired frame with frames preceding and following that frame, and recognizes the region for which there is no change in the information as the abnormal section. When the abnormal section is not present, the processor 111 makes a negative determination at step S715, and sets “No contamination” at step S716. When the abnormal section is present, the processor 111 makes a positive determination at step S715, and sets “Contamination detected” at step S717.

For example, the settings at the above-described step S716 and step S717 may include setting a flag showing the determination result, or storing the settings in the memory 112.

When the processor 111 executes the contamination detection processing, the processing shown in FIG. 4 returns to step S72. When “Contamination detected” is not set by the above-described contamination detection processing (no at step S72), the processor 111 advances the processing to step S73, and inputs, to the traveling device 12, the vehicle speed of the autonomous command in the route plan.

On the other hand, when “Contamination detected” is set by the above-described contamination detection processing (yes at step S72), the processor 111 advances the processing to step S74, and executes contamination amount calculation processing.

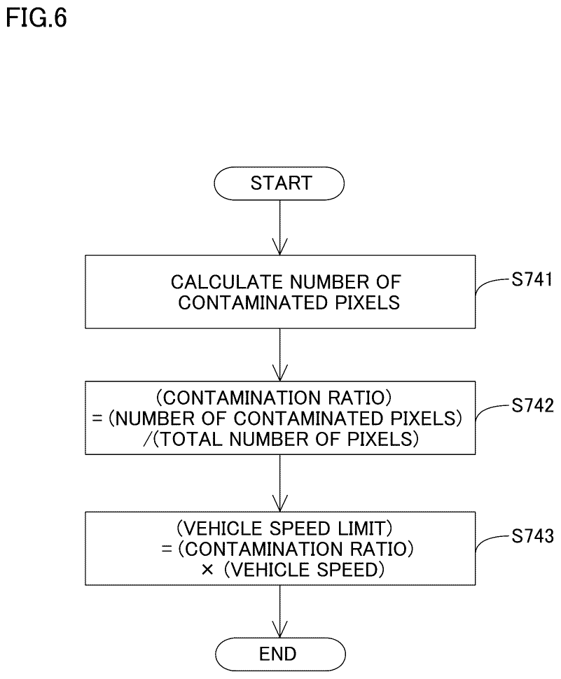

FIG. 6 is a flowchart showing an example of the contamination amount calculation processing. This processing is processing that decides a change amount and degree of change by which the vehicle behavior is to be changed when it is determined that contamination has been detected. In FIG. 6, for example, a change amount of the vehicle speed is calculated and decided.

For example, at step S741, the processor 111 calculates a number of contaminated pixels (number of contaminated regions) in the acquired output information.

At step S742, the processor 111 calculates a contamination ratio. For example, the processor 111 calculates the contamination ratio by dividing the number of contaminated pixels (number of contaminated regions) calculated at step S741 by a total number of pixels (total number of regions).

At step S743, the processor 111 calculates a vehicle speed limit. The vehicle speed limit is a speed for reducing (suppressing) the vehicle speed in the autonomous command. Suppressing the vehicle speed means causing the vehicle speed to decrease, and includes deceleration and stopping. The processor 111 calculates, as the vehicle speed limit, a speed obtained by multiplying the contamination ratio calculated at step S742 by the vehicle speed in the autonomous command. The vehicle speed limit is a magnitude by which the vehicle speed is to be reduced, and is greater the larger the contamination ratio.

When the processor 111 executes the contamination amount calculation processing, the processor 111 advances the processing to step S75 in FIG. 4, and, using the calculated vehicle speed limit, inputs the vehicle speed to the traveling device 12. In the present embodiment, the processor 111 inputs, to the traveling device 12, the vehicle speed obtained by subtracting the vehicle speed limit calculated at step S743 from the vehicle speed decided in the route planning, such as the current vehicle speed, for example. In this way, the vehicle 100 is caused to travel at the reduced vehicle speed.

As described above, in the present embodiment, the controller 11 (the processor 111) causes the change in behavior of the vehicle 100 when the abnormal section is present in the output information output by the vehicle surrounding environment detection unit 10. Thus, even when there is an impact on recognition of the surrounding environment, such as foreign material or the like attaching to the sensors included in the vehicle surrounding environment detection unit 10, for example, the behavior of the vehicle 100 can be changed, and the vehicle 100 can be caused to travel autonomously. Further, although foreign material, such as mud, easily attaches to the sensors during travel in the vehicle 100 traveling over the rough terrain, according to this mode, the autonomous travel of the vehicle 100 traveling over the rough terrain can be continued.

Further, in the present embodiment, the processor 111 can easily recognize the abnormal section, since the processor 111 acquires the output information as the information for each of the plurality of divided regions obtained by dividing up the surrounding situation.

Further, the processor 111 can achieve the vehicle behavior that accords with an abnormal state, since the processor 111 changes the vehicle behavior in accordance with a ratio and magnitude of the abnormal section.

When the abnormal section is present, namely, when the vehicle surrounding environment detection unit 10 cannot normally detect the surrounding situation, the processor 111 limits and reduces the vehicle speed as the vehicle behavior. Thus, the vehicle behavior that accords with the abnormal state can be achieved.

In the present disclosure, including the claims, the expression “at least one of A or B” means any one or both of A and B. That is, it encompasses (i) a case in which only A is satisfied, (ii) a case in which only B is satisfied, and (iii) a case in which both A and B are satisfied.

The following modifications can be further made to the above-described embodiment.

For example, at step S742, in place of the contamination ratio, the processor 111 may calculate a size of the number of contaminated pixels (a size of the abnormal section). At step S743, the processor 111 may calculate the vehicle speed limit such that the vehicle speed is reduced more the larger the size of the abnormal section.

For example, at step S742, the processor 111 may calculate a position of the contaminated region (abnormal section) in the output information. At step S743, the processor 111 may change the vehicle behavior in accordance with the position. For example, the processor 111 may calculate the vehicle speed limit such that the vehicle speed is reduced more the closer the position of the abnormal section in the output information is to a central section in the output information. The position of the abnormal section substantially corresponds to a position in an output unit of the sensor of the vehicle surrounding environment detection unit 10. Thus, according to this aspect, the behavior of the vehicle 100 can be caused to change in accordance with an abnormal state of the vehicle surrounding environment detection unit 10 (the sensor).

For example, the processor 111 may execute the contamination determination while taking into account a change amount of a posture. For example, when there is a region for which the update frequency is low in a state in which the change amount of the posture is equal to or greater than a predetermined amount, this region may be recognized as the abnormal section. According to this mode, a recognition accuracy of the abnormal section can be improved.

For example, changing the vehicle behavior may include operating vehicle components. For example, at step S75, the controller 11 may operate the foreign material removal device 10a, and may remove the contamination from the sensor in the vehicle surrounding environment detection unit 10 for which the contamination (the abnormal section) has been detected, or from a location corresponding to the abnormal section in the sensor. According to this mode, an impact on the travel of the vehicle 100 can be reduced.

For example, the controller 11 may operate the foreign material removal device 10a in accordance with the position of the abnormal section. For example, the foreign material removal device 10a may include wipers provided to the left and to the right with respect to a center in the left-right direction of a predetermined sensor included in the vehicle surrounding environment detection unit 10, and when the controller 11 determines, from the output information, that the position of the foreign material (an attached object) is at a right section with respect to a center section of the above-described sensor, the controller 11 may operate only the right wiper. Further, the controller 11 may change an operation amount of the wiper in accordance with a distance between the foreign material and the wiper. For example, the closer the distance between the foreign material and the wiper, the smaller the controller 11 makes a movement amount of the wiper. Further, the controller 11 may operate the foreign material removal device 10a in accordance with the size of the abnormal section. For example, the larger the abnormal section, the larger the controller 11 causes an operation amount to be.

For example, the controller 11 may operate the foreign material removal device 10a in accordance with a road surface situation, a travel situation, or a setting by a user. For example, when the vehicle 100 is traveling in a situation in which instability is high, such as an uneven or muddy road surface or the like, the controller 11 may bring forward a timing for operating the foreign material removal device 10a, or may cause the operation of the foreign material removal device 10a to be faster.

For example, changing the vehicle behavior may include changing the route in the autonomous travel. For example, in the route planning processing, the processor 111 may be configured to generate a plurality of candidates for the route, and decide the route along which to cause the vehicle 100 to travel from among the plurality of candidate routes. The processor 111 may reduce a priority of the candidate route along which the vehicle 100 will be caused to travel in a direction corresponding to a position of the abnormal section, and then decide the route along which the vehicle 100 is to be caused to travel from the plurality of candidate routes. According to this mode, an impact on the vehicle 100 due to the abnormal section can be reduced.

For example, the processor 111 may cause the behavior of the vehicle 100 to change in accordance with a current travel state, when the abnormal section is present. For example, the travel state may include the acceleration, the posture, a change in posture (a change in the steering angle or a change in an up-down position), the vehicle position, and the like, and the processor 111 may acquire these travel states from the travel index acquisition equipment 30 and the vehicle position detection unit 9. For example, when the acquired vehicle position is a position at which stable travel is possible, the processor 111 may reduce a degree of reduction of the vehicle speed. Further, in addition to the travel state, the processor 111 may change the vehicle behavior while taking into account a position of a region identified as the abnormal section, and a position of a non-abnormal section (a normal section). According to this mode, the vehicle 100 can be changed in accordance with the situation of the vehicle 100.

When it is detected that the output information includes the abnormal section, for example, when the positive determination is made at step S72, the processor 111 may notify the driver, via a notification unit (a notification device) of the information indicating that the abnormal section is present. The display device 20 and the audio input/output device 22 may function as the notification unit, or an output device other than these may function as the notification unit. According to this mode, the driver can ascertain that there is an abnormality in the sensor detecting the surrounding situation of the vehicle 100. Further, the driver can operate the foreign material removal device 10a and prompt the removal of the cause of the abnormality.

The vehicle 100 may include a setting cancellation unit, operated by the driver, for canceling the change in the vehicle behavior. The processor 111 may cancel the change in the vehicle behavior when, after changing the vehicle behavior, the processor 111 receives that the setting cancellation unit has been operated. In this case, the processor 111 may input, to the traveling device 12, a normal autonomous command. The display device 20 and the audio input/output device 22 may function as the setting cancellation unit, or an input device other than these may function as the setting cancellation unit. According to this mode, the driver can cancel the change of the vehicle behavior of the vehicle 100 in any given situation.

For example, when “No contamination” is determined (no at step S72) in the contamination detection processing executed a subsequent time after changing the vehicle behavior, the processor 111 may cancel the change in the vehicle behavior and may restore the vehicle 100 to the normal autonomous travel. Further, for example, the “No contamination” determination may be made when, in the output information, a size or range occupied by the abnormal section is less than a predetermined size or predetermined range. According to this mode, an impact on the travel of the vehicle 100 can be reduced.

When the processor 111 has caused the behavior of the vehicle 100 to change, the processor 111 may transmit, to an external device via the communication device 24, information indicating that the behavior of the vehicle 100 has been changed. The external device may be a management center of the vehicle 100 or a server device provided at a position separated from the vehicle 100. According to this mode, an administrator or the like can ascertain the state of the vehicle 100. In this mode, the transmitted information may include information relating to the surrounding environment that is the reason for causing the change in behavior of the vehicle 100. For example, the processor 111 may transmit, to the external device, information used in the determinations at step S71 and step S74, various information acquired at the time of execution or before and after the execution of the determinations, and information relating to the vehicle position at which the behavior change of the vehicle 100 has been executed. According to this mode, data management and analysis can be performed using the information transmitted to the external device.

For example, changing the vehicle behavior may include at least one of suppressing the acceleration, increasing a distance to a surrounding obstacle, and adjusting a threshold value of a sensor different from the sensor outputting the output information that is determined to include the abnormal section. Further, for example, changing the vehicle behavior may include switching the operation mode of the vehicle 100 from the automatic operation mode to the manual operation mode.

A correspondence between each of structural elements (features) of the above-described embodiment and each of structural elements (features) of the present disclosure is as described below. Note that each of the structural elements of the embodiment are merely examples, and are not intended to limit each of the structural elements of the present disclosure. The vehicle 100 is an example of a “vehicle”. The controller 11 and the processor 111 are an example of a “controller”. The traveling device 12 is an example of a “traveling device”. The vehicle surrounding environment detection unit 10 is an example of a “surrounding environment detection unit”. The foreign material removal device 10a is an example of a “vehicle component.” The display device 20 and the audio input/output device 22 are an example of a “notification device”. The display device 20 and the audio input/output device 22 are an example of a “setting cancellation unit”. The communication device 24 is an example of a “communication device”. The travel index acquisition equipment 30 and the vehicle surrounding environment detection unit 10 are an example of a “detection unit”.

The functionality of the elements disclosed herein may be implemented using one or more circuitry or processing circuitry which includes general purpose processors, special purpose processors, integrated circuits, ASICs (“Application Specific Integrated Circuits”), FPGAs (“Field Programmable Gate Arrays”) and/or conventional circuitry. The functionality of the elements disclosed herein may be implemented using one or more circuitry or processing circuitry which includes combinations of general purpose processors, special purpose processors, integrated circuits, ASICs, FPGAs, or conventional circuitry. The one or more circuitry or processing circuitry is programmed, using one or more programs stored together or individually in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality, alone or in combination with one another. The hardware may be any hardware disclosed herein which is programmed or configured to carry out the recited functionality. There is a memory that stores a computer program which includes computer instructions. The computer instructions provide the logic and routines that enable the hardware to perform the method disclosed herein. The hardware includes, e.g., processing circuitry or circuitry. The computer program can be implemented in known formats as a computer readable storage medium, a computer program product, a memory device, a record medium such as a CD-ROM or DVD, and/or the memory of a FPGAs or ASICs.

The present disclosure is not limited to the above-described embodiment and modified examples, and can be realized by various other aspects insofar as these do not depart from the gist and scope thereof. For example, the present disclosure can be realized by the following aspects. Each of technical features in the above-described embodiment and modified examples corresponding to technical features of each of the aspects described below can be switched or combined, as appropriate, in order to solve some or all of the issues of the present disclosure, or to achieve some or all of the effects of the present disclosure. Further, insofar as these technical features are not described as essential in the present specification, they may be omitted as appropriate.

What is claimed is:

1. A vehicle comprising:
a traveling device configured to cause the vehicle to travel;
a controller configured to cause the vehicle to perform autonomous travel, by outputting a travel command to the traveling device; and
a surrounding environment detection unit including at least one sensor configured to detect a surrounding situation of the vehicle and output the detected surrounding situation to the controller, wherein
the vehicle is an off-road vehicle capable of traveling over rough terrain,
the controller acquires output information output by the surrounding environment detection unit, and determines whether or not the acquired output information includes an abnormal section differing from an assumed output, and
the controller causes a change in behavior of the vehicle when the abnormal section is present.

2. The vehicle according to claim 1, wherein
the output information includes information for each of a plurality of divided regions obtained by dividing up the surrounding situation.

3. The vehicle according to claim 2, wherein
the controller acquires and updates the output information at a predetermined cycle, and
the controller determines whether or not the abnormal section is present based on at least one of a luminance value or an update frequency in each of the plurality of divided regions.

4. The vehicle according to claim 3, wherein
the controller recognizes, as the abnormal section, a region for which the update frequency is low compared to the other regions, of the plurality of divided regions.

5. The vehicle according to claim 1, wherein
the controller causes the change in the behavior of the vehicle in accordance with at least one of a size or a position of the abnormal section in the output information.

6. The vehicle according to claim 5, wherein
the controller causes the change in the behavior of the vehicle to be greater the larger the size of the abnormal section in the output information.

7. The vehicle according to claim 5, wherein
the controller causes the change in the behavior of the vehicle to be greater the closer the position of the abnormal section in the output information is to a central section in the output information.

8. The vehicle according to claim 1, wherein
the change in the behavior of the vehicle includes at least one of suppressing a speed of the vehicle, changing a route of the autonomous travel, and operating a vehicle component in the vehicle.

9. The vehicle according to claim 3, wherein
the controller generates a plurality of candidate routes for the route, and decides the route from among the plurality of candidate routes, and
in deciding the route, the controller lowers a priority of the candidate route, from among the plurality of candidate routes, on which the vehicle is caused to travel in a direction corresponding to the position of the abnormal section.

10. The vehicle according to claim 8, wherein
the vehicle component includes a foreign material removal device configured to remove foreign material attached to the at least one sensor, and
the controller operates the foreign material removal device in accordance with detection of the abnormal section.

11. The vehicle according to claim 1, comprising:
a notification device configured to perform notification of predetermined information to a driver, wherein
when the abnormal section is present, the controller performs the notification, via the notification device, of information indicating that the abnormal section is present.

12. The vehicle according to claim 1, wherein
when a size or a range, in the output information, occupied by the abnormal section is less than a predetermined size or a predetermined range, the controller cancels the change in the behavior of the vehicle.

13. The vehicle according to claim 1, further comprising:
a communication device configured to communicate with an external device outside the vehicle, wherein
when the controller has caused the change in the behavior of the vehicle, the controller outputs, to the external device via the communication device, information indicating that the change in the behavior of the vehicle has been caused.

14. The vehicle according to claim 1, comprising:
a setting cancellation unit operated by a driver, for canceling the change in the behavior of the vehicle, wherein
when the controller receives an operation of the setting cancellation unit, the controller cancels the change in the behavior of the vehicle.

15. The vehicle according to claim 1, comprising:
a communication device configured to communicate with an external device outside the vehicle, wherein
when the controller has caused the change in the behavior of the vehicle, the controller outputs, to the external device via the communication device, information relating to the surrounding environment that is a reason for causing the change in the behavior of the vehicle.

16. The vehicle according to claim 1, comprising:
a detection unit configured to detect a travel state of the vehicle, wherein when the abnormal section is present, the controller causes the change in the behavior of the vehicle in accordance with the travel state.

17. The vehicle according to claim 15, wherein
the controller causes the change in the behavior of the vehicle in accordance with least one of a size or a position of the abnormal section in the output information, and in accordance with the travel state.
